(19) United States
(12) Patent Application Publication
(10) Pub. No.: US 2025/0087858 A1
(43) Pub. Date: Mar. 13, 2025

(54) POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yozo UCHIDA, Toyota-shi (JP); Satoshi FUJIMURA, Toki-shi (JP); Yuki SATO, Toyota-shi (JP); Nozomi TATEYAMA, Okazaki-shi (JP); Masahiro UCHIMURA, Miyoshi-shi (JP); Masataka ASAI, Toyota-shi (JP); Shigeru MATSUMOTO, Toyohashi-shi (JP); Takashi TAKIMOTO, Kosai-shi (JP); Shunsuke NAKAMURA, Hamamatsu-shi (JP); Keitaro MACHIDA, Hamamatsu-shi (JP)

(21) Appl. No.: 18/677,882

(22) Filed: May 30, 2024

(30) Foreign Application Priority Data
Sep. 11, 2023 (JP) 2023-147105

(51) Int. Cl. H01M 50/59; H01G 11/66; H01G 11/74; H01G 11/78; H01M 50/15; H01M 50/176; H01M 50/184; H01M 50/188; H01M 50/193; H01M 50/198; H01M 50/553; H01M 50/588

(52) U.S. Cl. CPC H01M 50/59; H01G 11/66; H01G 11/74; H01G 11/78; H01M 50/15; H01M 50/176; H01M 50/184; H01M 50/188; H01M 50/193; H01M 50/198; H01M 50/553; H01M 50/588

(57) ABSTRACT

A power storage device includes a case lid with a terminal inserting hole, a current collecting terminal having a hole insertion portion inserted in the terminal inserting hole in a case front-back direction and an external connection portion continuous with the hole insertion portion and placed in parallel to the case lid on the case front-surface side, and an insulating resin member integrally molded with the current collecting terminal and the case lid to connect the hole insertion portion and the external connection portion to a hole outer edge portion and a hole surrounding portion. The insulating resin member includes a back-surface side insulating resin portion connecting a back surface of the external connection portion and the hole insertion portion to the hole outer edge portion and the hole surrounding portion. The back-surface side insulating resin portion is formed with a recessed portion opening on a case back-surface side.

### CROSS-REFERENCE TO RELATED APPLICATIONS

This application is based upon and claims the benefit of priority to Japanese Patent Application No. 2023-147105 filed on Sep. 11, 2023, the entire contents of which are incorporated herein by reference.

### BACKGROUND

### Technical Field

The disclosure relates to a power storage device.

### Related Art

For example, Japanese unexamined patent application publication No. 2021-086813 discloses a sealed power storage device in which an insulating resin member is integrally molded with a current collecting terminal and a case member (insert molding) so as to fill the space between the current collecting terminal and a terminal inserting hole of the case member.

### SUMMARY

### Technical Problems

However, the above-described insulating resin member is usually made of resin as a major material and thus is different in coefficient of linear expansion from the current correcting terminal and the case member, which are each made of metal. Therefore, when the completed sealed power storage device is subjected to a thermal endurance test in which cooling and heating cycles, for example. from −40° C. to +60° C., are repeated, tensile stress accumulates in a joined portion between the insulating resin member and the current collecting terminal or the case member, causing cracks in the insulating resin member that is lower in strength and thus decreasing the hermeticity (sealing property) of the interior of the case member.

The disclosure has been made to address the above problems and has a purpose to provide a power storage device, capable of reducing cracks in a joined portion between a current collecting terminal and a case member and an insulating resin member integrally molded with those current collecting terminal and case member due to heating and cooling, and thus improving the hermeticity, i.e., the sealing property, of the interior of the case member.

### Means of Solving the Problems

(1) To achieve the above-mentioned purpose, one aspect of the present disclosure provides a power storage device comprising: a case member having a terminal inserting hole; a current collecting terminal including: a hole insertion portion inserted through the terminal inserting hole in a case front-back direction of the case member; and an external connection portion continuous with the hole insertion portion and placed in parallel to the case member on a case front-surface side of the case member; and an insulating resin member integrally molded with the current collecting terminal and the case member, in which the hole insertion portion and the external connection portion are connected to a hole outer edge portion and a hole surrounding portion of the terminal inserting hole of the case member, wherein the insulating resin member includes a back-surface side insulating resin portion connecting a back surface of the external connection portion and the hole insertion portion of the current collecting terminal to the hole outer edge portion and the hole surrounding portion of the case member, and wherein the back-surface side insulating resin portion is formed with a recessed portion opening on a case back-surface side of the case member.

(2) In the power storage device described in (1), the recessed portion may have a bottom surface located on the case front-surface side, and the back-surface side insulating resin portion may include an insulating resin layer with a thickness of 200 μm or more between the back surface of the external connection portion and the bottom surface of the recessed portion.

(3) In the power storage device described (1) or (2), the recessed portion may be formed in a rectangular shape as viewed from the case back-surface side, and the back-surface side insulating resin portion may be provided with side wall surfaces defining the recessed portion and a connecting rib connecting opposing ones of the side wall surfaces to each other.

### BRIEF DESCRIPTION OF THE DRAWINGS

FIG. 1 is an exploded perspective view showing one form (an example) of a power storage device in an embodiment;

FIG. 2 is a partial perspective view of a part A shown in FIG. 1, which is viewed obliquely from a case back-surface side;

FIG. 3 is a cross-sectional view of a part of the power storage device in the embodiment, which is cut along a line B-B in FIG. 1;

FIG. 4 is a cross-sectional view of a part of a power storage device in a comparative example, which is cut along the line B-B in FIG. 1; and

FIG. 5 is a partial perspective view of a part of a power storage device in a modified example, corresponding to the part A in FIG. 1, which is viewed obliquely from the back-surface side.

### DETAILED DESCRIPTION OF THE EXEMPLARY EMBODIMENTS

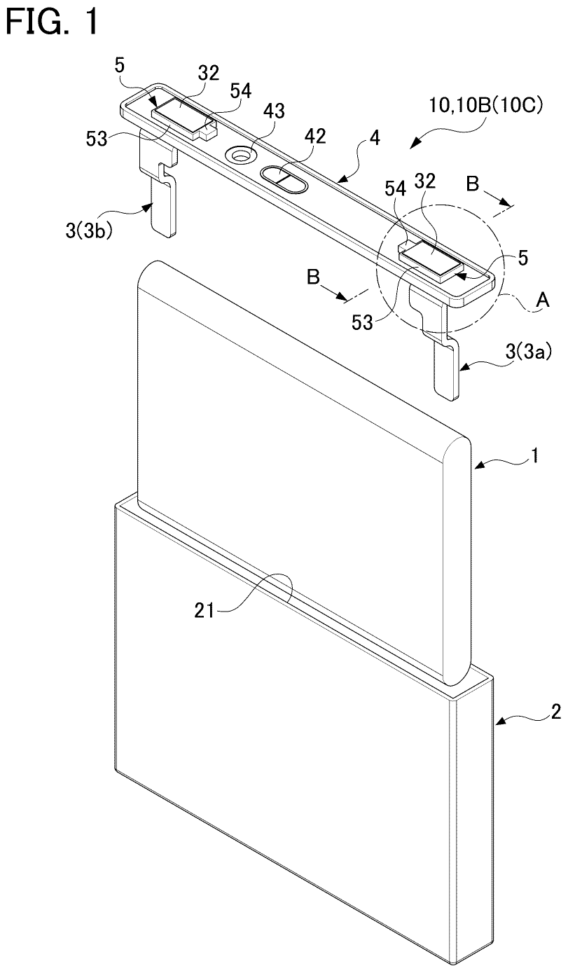

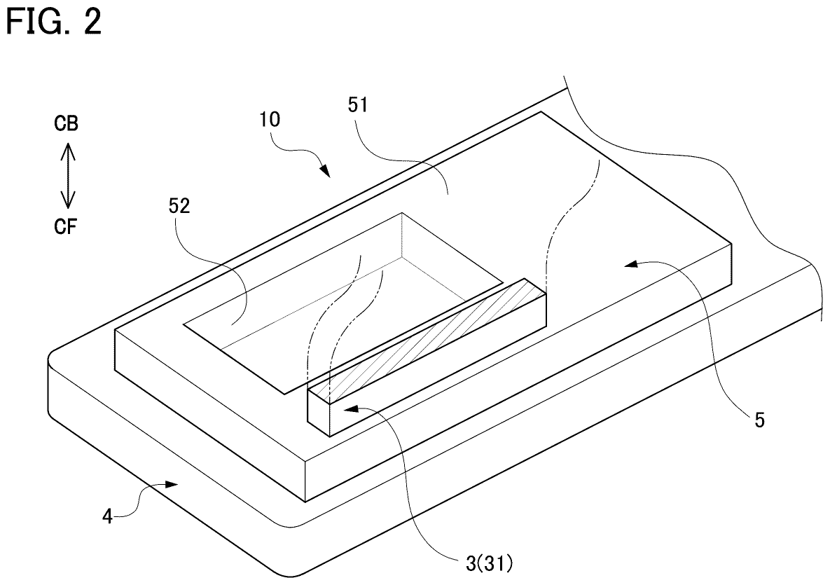

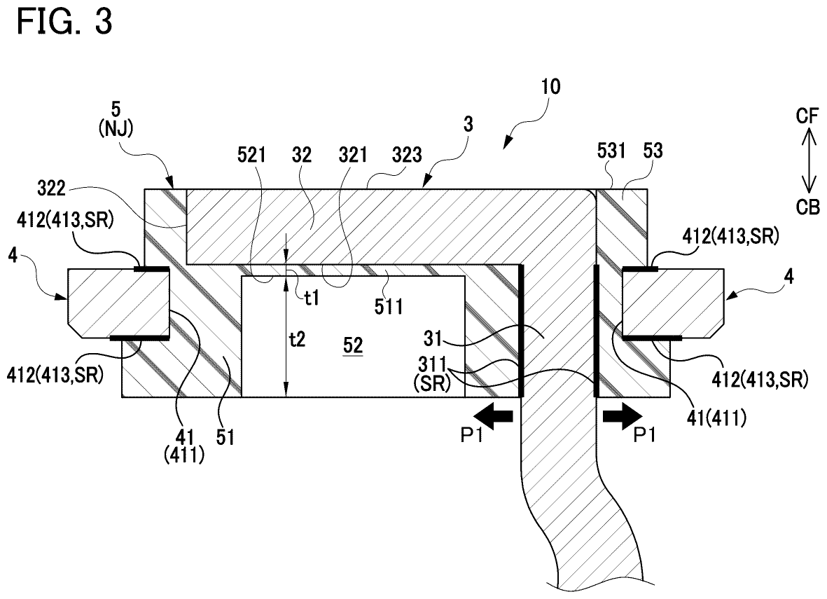

A detailed description of a power storage device 10, which is one form of typical embodiments of this disclosure, will now be given referring to the accompanying drawings. FIG. 1 is an exploded perspective view showing one form (an example) of the power storage device 10 in the embodiment. FIG. 2 is a partial perspective view of a part A in FIG. 1, which is viewed obliquely from a case back-surface side. FIG. 3 is a cross-sectional view of a part of the power storage device 10, which is cut along a line B-B in FIG. 1.

In the present embodiment, as shown in FIGS. 1 to 3, the power storage device 10 is provided with a case lid 4 (one example of a case member of the disclosure), current collecting terminals 3, and insulating resin members 5 each integrally molded (e.g., insert-molded) with the corresponding current collecting terminal 3 and the case lid 4. The case lid 4 includes a pair of terminal inserting holes 41 at both end portions in its longitudinal direction. The current collecting terminals 3 each include a hole insertion portion 31 inserted in the corresponding terminal inserting hole 41 in a case front-back direction, which is for example an inside-outside direction of the power storage device 10 shown as an upper-lower direction in FIG. 3, and an external connection portion 32 provided continuously with the hole insertion portion 31 and placed in parallel to the case lid 4 on a case front-surface side CF, which corresponds to the outside of the power storage device 10 in the figures. The external connection portion 32 is formed in a rectangular shape as viewed in plan view from the case front-surface side CF. The terminal inserting hole 41 is formed with a size that allows insertion of the hole insertion portion 31 and the external connection portion 32 of the current collecting terminal 3 in the case front-back direction. The hole insertion portion 31 and the external connection portion 32 are bent at a right angle to each other.

Further, as shown in FIG. 3, the insulating resin member 5 is integrally molded with the current collecting terminal 3 and the case lid 4 (insert molding), in which the hole insertion portion 31 and the external connection portion 32 of the current collecting terminal 3 are connected to a hole outer edge portion 411 and hole surrounding portions 412 of the case lid 4. The hole insertion portion 31 of the current collecting terminal 3 and the hole surrounding portions 412 of the case lid 4 are formed respectively with roughened surfaces 311 and 413 each extending in an annular shape with an arithmetic mean roughness in a range of 30 nm to 500 nm, for example, to make joined portions (i.e., sealing portions) SR with respect to the insulating resin member 5. The insulating resin member 5 is provided with a back-surface side insulating resin portion 51, which connects a back surface 321 of the external connection portion 32 and the hole insertion portion 31 of the current collecting terminal 3 to the hole outer edge portion 411 and the hole surrounding portions 412 of the case lid 4. The insulating resin member 5 is further provided with an outer-periphery-side insulating resin portion 53, which surrounds a side edge portion 322 of the external connection portion 32 over the entire circumference on the case front-surface side CF of the case lid 4. The volume of the outer-periphery-side insulating resin portion 53 is smaller than the volume of the back-surface side insulating resin portion 51. Furthermore, the external connection portion 32 has a front end surface (i.e., an outer end surface in FIG. 3) 323 located on the case front-surface side CF, and the outer-periphery-side insulating resin portion 53 has a front end surface (i.e., an outer end surface in FIG. 3) 531 located on the case front-surface side CF. Those front end surfaces 323 and 531 are formed flush with each other. The outer-periphery-side insulating resin portion 53 is formed with a resin injection portion (a gate portion) 54 at the position close to the center of the case lid 4, corresponding to a gate of a mold for injection of resin material that forms the insulating resin member 5.

The power storage device 10 in this embodiment includes an electrode body 1, a case body 2 having an opening 21 and housing the electrode body 1, the current collecting terminals 3 electrically connected to the electrode body 1, the case lid 4 having the terminal inserting holes 41 in which the current collecting terminals 3 are inserted and holding the electrode body 1 via the current collecting terminals 3 and closing the opening 21 of the case body 2, and the insulating resin member 5 integrally molded with the current collecting terminals 3 and the case lid 4 (insert molding) to connect the hole insertion portion 31 and the external connection portion 32 of each current collecting terminal 3 to the hole outer edge portion 411 and the hole surrounding portions 412 of the corresponding terminal inserting hole 41. However, the power storage device 10 is not necessarily limited to the above configuration. For example, the terminal inserting holes 41 may be formed in the case body 2. In the embodiment, the case body 2 and the case lid 4 constitute a case of the power storage device 10.

The power storage device 10 represents all power storage devices from which electrical energy can be extracted; for example, primary batteries, secondary batteries, and electric double layer capacitors. The electrode body 1 is a known electrode body in which a positive electrode sheet or plate with a positive active material layer and a negative electrode sheet or plate with a negative active material layer are wound or stacked by interposing separators therebetween. The case body 2 has a bottomed rectangular tube shape with the opening 21 at the upper end, and is made of aluminum or aluminum alloy, for example. The current collecting terminals 3 include a positive current collecting terminal 3a connected to a positive electrode side of the electrode body 1 and a negative current collecting terminal 3b connected to a negative electrode side of the electrode body 1. The positive current collecting terminal 3a is made of for example aluminum or aluminum alloy and the negative current collecting terminal 3b is made of for example copper or copper alloy. The case lid 4 is formed as a flat plate-like lid member made of aluminum or aluminum alloy, for example. This case lid 4 is formed with the terminal inserting holes 41 in which the current collecting terminals 3 are inserted in a one-to-one correspondence, a known safety valve 42, and a liquid inlet 43 for injection of an electrolyte.

The insulating resin member 5 has a thermoplastic resin material NJ having heat resistance, moldability, insulating property, sealing property, resistance to the electrolyte, and others. The thermoplastic resin material NJ in this embodiment is polyphenylene sulfide (PPS) resin, but is not limited thereto. Further, the thermoplastic resin material NJ forming the insulating resin member 5 may contain reinforcing materials, such as glass fibers, or elastomers, so on. When the insulating resin member 5 contains 50% by weight of glass fibers mixed with the base PPS resin and, the linear expansion coefficient in the flow direction of resin material during injection molding is 0.97×10⁻⁵/° C., the linear expansion coefficient in the right-angled direction with respect to the flow direction is 4.13×10⁻⁵/° C., and the average (randomly oriented) linear expansion coefficient (i.e., the average linear expansion coefficient of the insulating resin member 5 containing randomly oriented glass fibers) is 2.54×10⁻⁵/° C. In contrast, the linear expansion coefficient of aluminum that forms the case lid 4 and the positive current collecting terminal 3a is 2.4×10⁻⁵/° C. and the linear expansion coefficient of copper that forms the negative current collecting terminal 3b is 1.8×10⁻⁵/° C.

The linear expansion coefficient of the insulating resin member 5 is different from those of the case lid 4 and the current collecting terminal 3 (the positive current collecting terminal 3a and the negative current collecting terminal 3b). Therefore, when the power storage device 10 is subjected to a thermal endurance test, tensile stress accumulates in the joined portions (i.e., the sealing portions) SR between the insulating resin member 5 and the current collecting terminal 3 or the case lid 4, which may cause cracks in the insulating resin member 5, which is weaker in strength than the current collecting terminal 3 and the case lid 4.

In the power storage device 10 in this embodiment, therefore, as shown in FIGS. 2 and 3, the back-surface side insulating resin portion 51 is formed with a recessed portion 52, which is a wall-thickness reducing recess and opens on a case back-surface side CB, which corresponds to the inside of the power storage device 10 in the figures, in order to reduce the occurrence of cracks in the joined portions (i.e., the sealing portions) SR of the insulating resin member 5 due to thermal contraction. Note that the back-surface side insulating resin portion 51 has an insulating resin layer 511 with a predetermined thickness t1 between the back surface 321 of the external connection portion 32 and a bottom surface 521 of the recessed portion 52, located on the case front-surface side CF. The recessed portion 52 has a depth t2 larger than the thickness t1 of the insulating resin layer 511 in the case front-back direction. This recessed portion 52 can reduce deformation resistance of the back-surface side insulating resin portion 51 connecting the back surface 321 of the external connection portion 32 and the hole insertion portion 31 of the current collecting terminal 3 to the hole outer edge portion 411 and the hole surrounding portions 412 of the case lid 4. This can reduce the tensile stress P1 acting on the joined portions SR between the hole insertion portion 31 of the current collecting terminal 3 and the back-surface side insulating resin portion 51. Further, since the back-surface side insulating resin portion 51 includes the insulating resin layer 511, it can avoid for example water penetration from the outside via the recessed portion 52. Consequently, the above configuration can reduce the occurrence of cracks in the insulating resin member 5 at the joined portions (i.e., the sealing portions) SR between the insulating resin member 5 and the current collecting terminal 3 or the case lid 4, and can improve the hermeticity (the sealing property) of the interior of the case, composed of the case body 2 and the case lid 4. The thickness t1 of the insulating resin layer 511 may be 200 μm or more, for example. Such an insulating resin layer 511 with the thickness t1 of 200 μm or more can block the passage of fine particles of water through gaps between molecules in the insulating resin layer 511, and therefore can maintain its water-tightness.

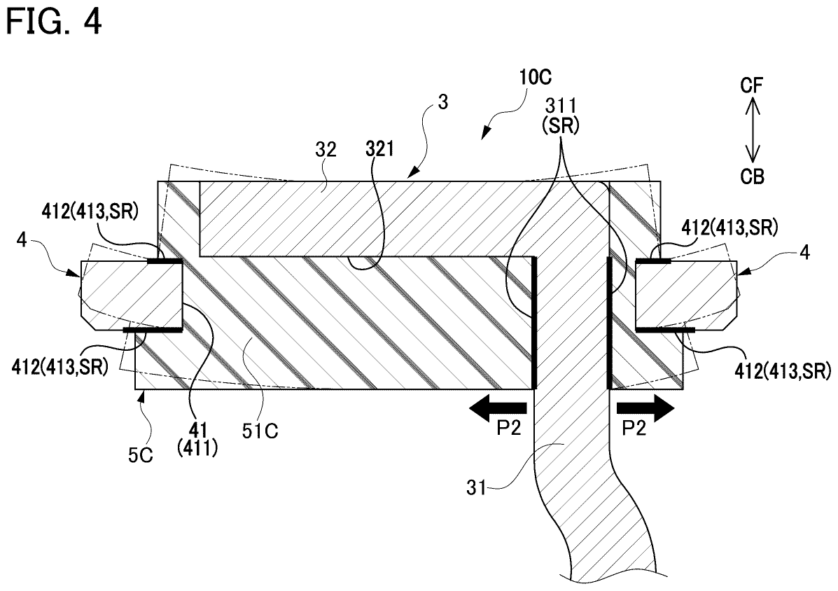

In contrast, FIG. 4 is a cross-sectional view of a part of a power storage device 10C in a comparative example, which is cut along the line B-B in FIG. 1. In this power storage device 10C in the comparative example, as shown in FIG. 4, a back-surface side insulating resin portion 51C connecting the back surface 321 of the external connection portion 32 and the hole insertion portion 31 of the current collecting terminal 3 to the hole outer edge portion 411 and the hole surrounding portions 412 of the case lid 4 is not formed with the recessed portion 52 shown in FIGS. 2 and 3. The power storage device 10C in the comparative example is identical in structure to the foregoing power storage device 10 in the present example, except for the recessed portion 52, and therefore assigned the same reference signs as those of the power storage device 10. Accordingly, when the power storage device 10C in the comparative example is cooled to about −40° C., for example, the case lid 4 and the external connection portion 32 of the current collecting terminal 3 try to shrink, but are resisted by the back-surface side insulating resin portion 51C, which less shrinks, and thus are deformed in a direction to warp convexly on the case back-surface side CB of the back-surface side insulating resin portion 51. This causes an increase in tensile stress P2 acting on the joined portions SR between the hole insertion portion 31 of the current collecting terminal 3 and the back-surface side insulating resin portion 51C. Consequently, this configuration is likely to cause cracks in the insulating resin member 5 at the joined portions (the sealing portions) SR between the insulating resin member 5 and the current collecting terminal 3 or the case lid 4, resulting in deteriorated hermeticity, or sealing property, of the interior of the case.

With the above-described configuration, the power storage device 10 provided in the present embodiment can reduce the occurrence of cracks in the insulating resin member 5 at the joined portions (the sealing portions) SR between the current collecting terminal 3 and the resin member 5, and between the case lid 4 and the insulating resin member 5, due to heating and cooling, and improve the hermeticity, i.e., the sealing property, of the interior of the case.

### Modified Example

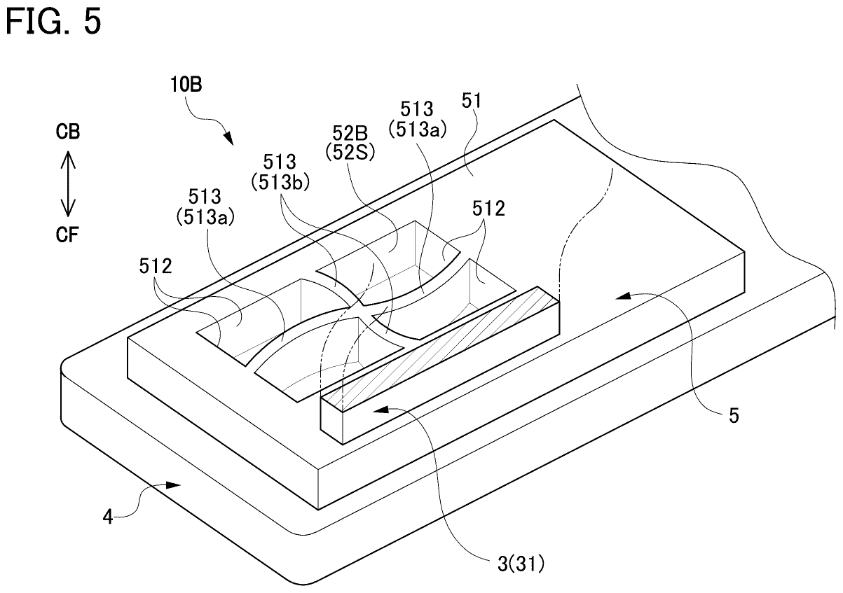

The foregoing embodiments are mere examples and give no limitation to the present disclosure. The present disclosure may be embodied in other specific forms without departing from the essential characteristics thereof. For instance, the recessed portion 52 shown in FIGS. 2 and 3 is formed as a rectangular hollow part opening on the case back-surface side CB, but is not limited to this form. In one modified example, as shown in FIG. 5, a power storage device 10B may be configured such that a recessed portion 52B is formed in a rectangular shape as viewed from the case back-surface side CB, and the back-surface side insulating resin portion 51 is provided with the side wall surfaces 512 defining the recessed portion 52 and connecting ribs 513 each connecting opposing ones of the side wall surfaces 512. With the connecting ribs 513 connecting the side wall surfaces 512 to each other, the back-surface side insulating resin portion 51 can connect the current collecting terminal 3 and the case lid 4 with enhanced connecting force. Further, the connecting ribs 513 can expand and contract during heating and cooling, so that the insulating resin member 5 is suppressed from cracking due to heating and cooling. The connecting ribs 513 are each formed in a curved line in FIG. 5, but not limited thereto, and may be formed in a straight line. The connecting ribs 513 may include a longitudinal-direction connecting rib 513a extending in the longitudinal direction of the case lid 4 and a width-direction connecting rib 513b extending in the width direction of the case lid 4 or may include only either the longitudinal-direction connecting rib 513a or the width-direction connecting rib 513b.

### REFERENCE SIGNS LIST

3 Current collecting terminal
4 Case lid
5 Insulating resin member
10, 10B Power storage device
31 Hole insertion portion
32 External connection portion
41 Terminal inserting hole
51 Back-side insulating resin portion
52,52B Recessed portion
411 Hole outer edge portion
412 Hole surrounding portion
512 Side wall surface
513 Connecting rib

What is claimed is:

1. A power storage device comprising:
a case member having a terminal inserting hole;
a current collecting terminal including:
a hole insertion portion inserted through the terminal inserting hole in a case front-back direction of the case member; and
an external connection portion continuous with the hole insertion portion and placed in parallel to the case member on a case front-surface side of the case member; and
an insulating resin member integrally molded with the current collecting terminal and the case member, in which the hole insertion portion and the external connection portion are connected to a hole outer edge portion and a hole surrounding portion of the terminal inserting hole of the case member,
wherein the insulating resin member includes a back-surface side insulating resin portion connecting a back surface of the external connection portion and the hole insertion portion of the current collecting terminal to the hole outer edge portion and the hole surrounding portion of the case member, and
wherein the back-surface side insulating resin portion is formed with a recessed portion opening on a case back-surface side of the case member.

2. The power storage device according to claim 1, wherein
the recessed portion has a bottom surface located on the case front-surface side, and
the back-surface side insulating resin portion includes an insulating resin layer with a thickness of 200 μm or more between the back surface of the external connection portion and the bottom surface of the recessed portion.

3. The power storage device according to claim 1, wherein
the recessed portion is formed in a rectangular shape as viewed from the case back-surface side, and
the back-surface side insulating resin portion is provided with side wall surfaces defining the recessed portion and a connecting rib connecting opposing ones of the side wall surfaces to each other.

4. The power storage device according to claim 2, wherein
the recessed portion is formed in a rectangular shape as viewed from the case back-surface side, and
the back-surface side insulating resin portion is provided with side wall surfaces defining the recessed portion and a connecting rib connecting opposing ones of the side wall surfaces to each other.
